(19) United States
(12) Patent Application Publication
(10) Pub. No.: US 2023/0089703 A1
(43) Pub. Date: Mar. 23, 2023

(54) CROSS-SHEATH FILAMENTS INCLUDING BLOWING AGENT

(71) Applicant: 3M INNOVATIVE PROPERTIES COMPANY, St. Paul, MN (US)

(72) Inventors: Jeffrey P. Kalish, St. Paul, MN (US); Thomas Q. Chastek, St. Paul, MN (US); Jacob D. Young, St. Paul, MN (US); Shaun M. West, St. Paul, MN (US); Jason D. McNulty, Stillwater, MN (US)

(21) Appl. No.: 17/787,775

(22) PCT Filed: Dec. 16, 2020
(86) PCT No.: PCT/IB2020/062068

§ 371 Date: Jun. 21, 2022

Related U.S. Application Data
(60) Provisional application No. 62/952,974, filed on Dec. 23, 2019.

(51) Int. Cl. B29C 64/118; B33Y 10/00; B33Y 70/00; D01F 8/06; D01D 5/34; C08J 9/10; C08J 9/228; C09J 5/08

(52) U.S. Cl. CPC B29C 64/118; B33Y 10/00; B33Y 70/00; D01F 8/06; D01D 5/34; C08J 9/10; C08J 9/228; C09J 5/08; D10B 2321/121; D10B 2401/08; C08J 2203/04; C08J 2203/22; C08J 2325/06

(57) ABSTRACT

Core-sheath filaments comprising cores including a polymer and 1 wt. % to 10 wt. % of a blowing agent, that can be dispensed as the core in a core-sheath construction. Dispensed adhesive compositions comprising the disclosed core-sheath filaments, the dispensed adhesive composition being a product resulting from compounding the core-sheath filament through a heated extruder nozzle. Methods of preparing core-sheath filaments.

### TECHNICAL FIELD

The present disclosure broadly relates to core-sheath filaments including adhesive cores and non-tacky sheaths.

### BACKGROUND

The use of fused filament fabrication (FFF) to produce three-dimensional articles has been known for a relatively long time, and these processes are generally known as methods of so called 3D printing (or additive manufacturing). In FFF, a plastic filament is melted in a moving printhead to form a printed article in a layer by layer, additive manner. The filaments are often composed of polylactic acid, nylon, polyethylene terephthalate (typically glycol-modified), or acrylonitrile butadiene styrene.

### SUMMARY

Pressure-sensitive adhesives are normally tacky at room temperature and can be adhered to a surface by application of light finger pressure and thus may be distinguished from other types of adhesives that are not pressure-sensitive. A general description of pressure-sensitive adhesives may be found in the Encyclopedia of Polymer Science and Engineering, Vol. 13, Wiley-Interscience Publishers (New York, 1988). Additional description of pressure-sensitive adhesives may be found in the Encyclopedia of Polymer Science and Technology, Vol. 1, Interscience Publishers (New York, 1964). “Pressure sensitive adhesive” or “PSA”, as used herein, refers to a viscoelastic material that possesses the following properties: (1) aggressive and permanent tack, (2) adherence to a substrate other than a fluorothermoplastic film with no more than finger pressure, and (3) sufficient cohesive strength to cleanly release from the substrate. A pressure-sensitive adhesive may also meet the Dahlquist criterion described in Handbook of Pressure-Sensitive Adhesive Technology, D. Satas, 2^{nd} ed., page 172 (1989). This criterion defines a pressure-sensitive adhesive as one having a one-second creep compliance of greater than 1×10⁻⁶ cm²/dyne at its use temperature (for example, at temperatures in a range of from 15° C. to 35° C.).

As used herein, “core-sheath filament” refers to a composition in which a first material (i.e., the core) is surrounded by a second material (i.e., the sheath) and the core and sheath have a common longitudinal axis. Preferably, the core and the sheath are concentric. The ends of the core do not need to be surrounded by the sheath.

As used herein, the term “blowing agent” refers to chemical blowing agents, physical blowing agents, and expandable microspheres which may be employed to assist in forming foamed materials.

As used herein, the term “non-tacky” refers to a material that passes a “Self-Adhesion Test”, in which the force required to peel the material apart from itself is at or less than a predetermined maximum threshold amount, without fracturing the material. The Self-Adhesion Test is described below and is typically performed on a sample of the sheath material to determine whether or not the sheath is non-tacky.

As used herein, “melt flow index” refers to the amount of polymer that can be pushed through a die at a specified temperature using a specified weight. Melt Flow Index can be determined using ASTM 1238-13, Procedure A, using the conditions of Table 7 (and if a polymer is not listed in Table 7, using the conditions of Table X4.1 for the polymer having the highest listed weight and highest listed temperature).

As used herein, “integral” refers to being made at the same time or being incapable of being separated without damaging one or more of the (integral) parts.

As used herein, the term “(meth)acrylate” is a shorthand reference to acrylate, methacrylate, or combinations thereof; “(meth)acrylic” is a shorthand reference to acrylic, methacrylic, or combinations thereof; and “(meth)acryloyl” is a shorthand reference to acryloyl, methacryloyl, or combinations thereof. As used herein, “(meth)acrylate-functional compounds” are compounds that include, among other things, a (meth)acrylate moiety.

As used herein, “alkyl” includes straight-chained, branched, and cyclic alkyl groups and includes both unsubstituted and substituted alkyl groups. Unless otherwise indicated, the alkyl groups typically contain from 1 to 20 carbon atoms. Examples of “alkyl” as used herein include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, and norbornyl, and the like. Unless otherwise noted, alkyl groups may be mono- or polyvalent, i.e., monovalent alkyl or polyvalent alkylene.

As used herein, “heteroalkyl” includes both straight-chained, branched, and cyclic alkyl groups with one or more heteroatoms independently selected from S, O, and N with both unsubstituted and substituted alkyl groups. Unless otherwise indicated, the heteroalkyl groups typically contain from 1 to 20 carbon atoms. Examples of “heteroalkyl” as used herein include, but are not limited to, methoxy, ethoxy, propoxy, 3,6-dioxaheptyl, 3-(trimethylsilyl)-propyl, 4-dimethylaminobutyl, and the like. Unless otherwise noted, heteroalkyl groups may be mono- or polyvalent, i.e., monovalent heteroalkyl or polyvalent heteroalkylene.

By “carboxyl” is meant —COOH groups, it being understood that such groups can exist in their neutral (—COOH) form, or can exist in their deprotonated (—COO) form.

As used herein, “halogen” includes F, Cl, Br, and I.

As used herein, “aryl” is an aromatic group containing 5-18 ring atoms and can contain optional fused rings, which may be saturated, unsaturated, or aromatic. Examples of an aryl groups include phenyl, naphthyl, biphenyl, phenanthryl, and anthracyl. Heteroaryl is aryl containing 1-3 heteroatoms such as nitrogen, oxygen, or sulfur and can contain fused rings. Some examples of heteroaryl groups are pyridyl, furanyl, pyrrolyl, thienyl, thiazolyl, oxazolyl, imidazolyl, indolyl, benzofuranyl, and benzthiazolyl. Unless otherwise noted, aryl and heteroaryl groups may be mono- or polyvalent, i.e., monovalent aryl or polyvalent arylene.

As used herein, “heteroaromatic” is an aromatic group containing 1-3 heteroatoms such as nitrogen, oxygen, or sulfur, and can contain fused rings, e.g., substituted phenyl groups.

As used herein, “acryloyl” is used in a generic sense and mean not only derivatives of acrylic acid, but also amine, and alcohol derivatives, respectively. “(meth)acryloyl” includes both acryloyl and methacryloyl groups; i.e., is inclusive of both esters and amides.

As used herein, “oligomer” refers to a molecule that has one or more properties that change upon the addition of a single further repeat unit.

As used herein, “polymer” refers to a molecule having one or more properties that do not change upon the addition of a single further repeat unit. The polymer can be a homopolymer, copolymer, terpolymer, and the like. The term “copolymer” means that there are at least two monomers used to form the polymer.

As used herein, “macromer” refers to an oligomer or polymer having a functional group at the chain end, and is a shortened version of the term “macromolecular monomer”.

As used herein, the term “styrenic” refers to materials, and/or components, and/or copolymers, and/or glassy blocks that are derived from styrene or another mono-vinyl aromatic monomer similar to styrene.

As used herein, the terms “glass transition temperature” and “T_{g}” are used interchangeably and refer to the glass transition temperature of a material or a mixture. Unless otherwise indicated, glass transition temperature values are determined by Differential Scanning Calorimetry (DSC).

As used herein, “thermoplastic” refers to a polymer that flows when heated sufficiently above its glass transition point and become solid when cooled.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

Features and advantages of the present disclosure will be further understood upon consideration of the detailed description as well as the appended claims.

### BRIEF DESCRIPTION OF THE DRAWINGS

FIG. 1 is a schematic perspective exploded view of a section of a core-sheath filament, according to an embodiment of the present disclosure.

FIG. 2 is a schematic cross-sectional view of a core-sheath filament, according to an embodiment of the present disclosure.

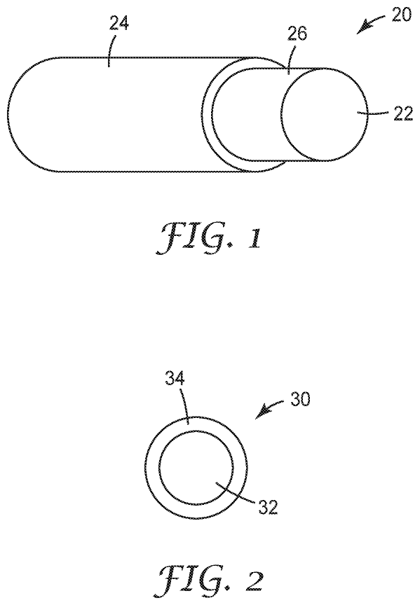

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

Adhesive transfer tapes have been used extensively for adhering a first substrate to a second substrate. Adhesive transfer tapes are typically provided in rolls and contain a pressure-sensitive adhesive layer positioned on a release liner or between two release liners, and because transfer adhesive tapes often need to be die-cut to the desired size and shape prior to application to a substrate, the transfer adhesive tape that is outside the die-cut area is discarded as waste. The core-sheath filaments described herein can be used to deliver a pressure-sensitive adhesive (also referred to herein as a “hot-melt processable adhesive”) without the use of a release liner and with less waste. The non-tacky sheath allows for easy handling of the hot-melt processable adhesive before deposition on a substrate. Furthermore, the use of the core-sheath filaments described herein as the adhesive composition can substantially reduce the waste often associated with adhesive transfer tapes as no die-cutting is required because the adhesive is deposited only in the desired area.

The disclosed core-sheath filaments can be used for printing a hot-melt processable adhesive using fused filament fabrication (“FFF”). The material properties needed for FFF dispensing typically are significantly different than those required for hot-melt dispensing of a pressure-sensitive adhesive composition. For instance, in the case of traditional hot-melt adhesive dispensing, the adhesive is melted into a liquid inside a tank and pumped out through a hose and nozzle. Thus, traditional hot-melt adhesive dispensing requires a low-melt viscosity adhesive, which is often quantified as a high melt flow index (“MFI”) adhesive. If the viscosity is too high (or the MFI is too low), the hot-melt adhesive cannot be effectively transported from the tank to the nozzle. In contrast, FFF involves melting a filament only within a nozzle at the point of dispensing, and therefore is not limited to low melt viscosity adhesives (high melt flow index adhesives) that can be easily pumped. In fact, a high melt viscosity adhesive (a low melt flow index adhesive) can advantageously provide geometric stability of a hot-melt processable adhesive after dispensing, which allows for precise and controlled placement of the adhesive as the adhesive does not spread excessively after being printed.

In addition, suitable filaments for FFF typically need at least a certain minimum tensile strength so that large spools of filament can be continuously fed to a nozzle without breaking. The FFF filaments are usually spooled into level wound rolls. When filaments are spooled into level wound rolls, the material nearest the center can be subjected to high compressive forces. Preferably, the core-sheath filament is resistant to permanent cross-sectional deformation (i.e., compression set) and self-adhesion (i.e., blocking during storage).

Provided herein are adhesive systems including pressure-sensitive adhesives (“PSA”) that are hot-melt processable, i.e., hot-melt processable adhesives. The hot-melt processable adhesives are in a filament core/sheath form factor having a core and a non-tacky sheath such that the hot-melt processable adhesives can be thermally cured by compounding the core-sheath filament through a heated extruder nozzle. Delivery of the hot-melt processable adhesives can be completed via hotmelt dispense including techniques used in filament-based additive manufacturing.

The disclosed core-sheath filaments include a core that is encapsulated by a sheath that prevents the wound filament from sticking to itself, enables easy unwind during additive manufacturing and other dispensing, and provides structural integrity such that the core-sheath filaments can be advanced to a heated extruder nozzle by mechanical means. Typically, the sheath is thin, has a composition such that it melts and mixes homogenously with the hot-melt processable adhesive core at the printer/extruder nozzle before application onto substrates, and has no surface tackiness at normal storage conditions.

Development of the core-sheath architecture requires the use of PSA formulations with some particular characteristics. For example, useful PSA formulations must have the appropriate melt-flow characteristics for co-extrusion with the sheath material during preparation of the core-sheath filament. Also, the PSA formulation must be stable in the core-sheath filament until it is dispensed for use. For a PSA that relies on thermal activation of a blowing agent, such as PSA formulations of the present disclosure, an additional requirement is that the blowing agent must remain largely, if not entirely, unactivated during manufacture of the core-sheath filament. Therefore, since both manufacture and use of the disclosed core-sheath filaments involve hot-melt extrusion, PSA compositions must be formulated such that both adhesive curing and formation of the foamed material do not occur until after the PSA has been dispensed by an end user. Disclosed herein are formulations that solve at least these problems, as they are stable during preparation of the core-sheath filament, but then are readily activated, i.e., foaming is initiated, upon compounding of the core-sheath filament through a heated extruder nozzle. Moreover, after cooling, the disclosed compositions have the required balance of cohesion and adhesion.

In the present disclosure core-sheath filaments are provided that comprise cores including a polymer and 1 wt. % to 10 wt. % of a blowing agent, that can be dispensed as the core in a core-sheath construction. The disclosed formulations provide dependable adhesion to both polar and non-polar surfaces, in addition to providing barriers to air and moisture, which is beneficial in many applications.

### Core-Sheath Filament:

In a first aspect, a core-sheath filament is provided. The core-sheath filament comprises an adhesive core and a non-tacky sheath including a polyolefin. In some embodiments, the sheath exhibits a melt flow index of less than 15 grams per 10 minutes (g/10 min). Referring to FIG. 2, a schematic perspective exploded view of a section of a core-sheath filament 20 is provided, comprising a core 22 and a sheath 24 encasing the outer surface 26 of the core 22.

Typically, the core-sheath filament has a relatively narrow diameter, to allow for use in precise applications of an adhesive. For instance, the core-sheath filament can comprise an average diameter of 1 millimeter (mm) or greater, 2 mm or greater, 3 mm or greater, 4, mm or greater, or 5 mm or greater; and 20 mm or less, 18 mm or less, 15 mm or less, or 12 mm or less. Stated another way, the core-sheath filament may comprise an average diameter of 1 to 20 mm, inclusive; 8 to 12 mm, inclusive; or 10 mm.

Often, the core-sheath filament has an aspect ratio of length to diameter of 50:1 or greater, 100:1 or greater, or 250:1 or greater. Core-sheath filaments having a length of at least about 20 feet (6 meters) can be useful in a method according to the present disclosure. Depending on the application of use of the core-sheath filament, having a relatively consistent diameter over its length can be desirable. For instance, an operator might calculate the amount of material being melted and dispensed based on the expected mass of filament per predetermined length, but if the mass per length varies widely, the amount of material dispensed may not match the calculated amount. In some embodiments, the core-sheath filament comprises a maximum variation of diameter of 20% over a length of 50 centimeters (cm), or even a maximum variation in diameter of 15% over a length of 50 cm. In preferred embodiments, the core-sheath filament has a cylindrical shape, i.e., the core-sheath filament is in the shape or form of a cylinder.

Filaments, or strands, according to the present disclosure and/or useful for practicing some embodiments of the method of the present disclosure, can generally be made using techniques known in the art for making filaments. Filaments, or strands, can be made by extrusion through a die, such as a coaxial die to form the core-sheath structure.

Core-sheath filaments described herein can exhibit a variety of desirable properties, both as prepared and as an adhesive. As formed, a core-sheath filament has strength consistent with being handling by a person without fracture of the sheath. The extent of structural integrity of the core-sheath filament needed varies according to the specific application of use. Preferably, a core-sheath filament has strength consistent with the requirements and parameters of one or more additive manufacturing devices (e.g., 3D printing systems). One additive manufacturing apparatus, however, could subject a polymeric filament to a greater force when feeding the filament to a deposition nozzle than a different apparatus. Advantageously, the elongation at break of the sheath material of the core-sheath filament is typically 50% or greater, 60% or greater, 80% or greater, 100% or greater, 250% or greater, 400% or greater, 750% or greater, 1000% or greater, 1400% or greater, or 1750% or greater; and 2600% or less, 2200% or less, 900% or less, 500% or less, or 200% or less. Stated another way, the elongation at break of the sheath material of the core-sheath filament can range from 50% to 2600%. In some embodiments, the elongation at break is at least 60%. Elongation at break can be measured, for example, by the methods outlined in ASTM D638-14, using test specimen Type IV.

In some embodiments, filaments, or strands, according to the present disclosure and/or useful for practicing some embodiments of the method of the present disclosure are made by extrusion through a coaxial die. Optional additives can be added to an adhesive composition in an extruder (e.g., a twin-screw extruder) equipped with a side stuffer that allows for the inclusion of additives. Similarly, optional additives can be added to a sheath composition in the extruder. The adhesive core can be extruded through the center layer of a coaxial die having an appropriate diameter while the non-tacky sheath can be extruded through the outer layer of the coaxial die. Often, the shape of the center layer is circular or oval, and the shape of the outer layer is concentric around the center layer. One suitable die is a filament spinning die as described in U.S. Pat. No. 7,773,834 (Ouderkirk et al.). Optionally, the strand can be cooled upon extrusion using a water bath. The filament can be lengthened using a belt puller. The speed of the belt puller can be adjusted to achieve a desired filament diameter.

Advantages provided by at least certain embodiments of employing the core-sheath filament as an adhesive once it is melted and mixed include one or more of: low volatile organic compound (VOC) characteristics, avoiding die cutting, design flexibility, achieving intricate non-planar bonding patterns, printing on thin and/or delicate substrates, and printing on an irregular and/or complex topography.

Without wishing to be bound by theory, it is believed that the overall final adhesive material property of a dispensed core-sheath filament will demonstrate viscoelasticity; i.e., demonstrating stress relaxation over time. On the other hand, a desirable property of the sheath material is its ability to hold energy under a static load, showing minimal stress dissipation over time. A low MFI and a high tensile strength help prevent the core-sheath filament from breaking when subjected to high inertial forces, such as when the core-sheath is starting to be unspooled.

In some cases, it is advantageous to balance the sheath requirements and the overall adhesive performance by using a sheath material that can play a functional role in the overall adhesive. For example, a non-tacky styrenic block copolymer or an acrylic copolymer can be used in the sheath at relatively high concentrations without negatively impacting overall adhesion of dispensed filament. Preferably, the adhesive core comprises a pressure sensitive adhesive. In certain embodiments, when the core-sheath filament is melted and the core and sheath are mixed together to form a mixture, the mixture exhibits a glass transition temperature (T_{g}) of 0° C. or less, −10° C. or less, or −20° C. or less.

Suitable components of the core-sheath filament are described in detail below.

### Core

The core typically makes up 50 wt. % or more of the total core-sheath filament, 55 wt. % or more, 60 wt. % or more, 65 wt. % or more, 70 wt. % or more, 75 wt. % or more, 80 wt. % or more, 85 wt. % or more, or even 90 wt. % or more of the total weight of the core-sheath filament; and 96 wt. % or less, 94 wt. % or less, 90 wt. % or less, 85 wt. % or less, 80 wt. % or less, 70 wt. % or less, or 65 wt. % or less of the total weight of the core-sheath filament. Stated another way, the sheath can be present in an amount of 50 wt. % to 96 wt. % of the core-sheath filament, 60 to 90 wt. %, 70 to 90 wt. %, 50 to 70 wt. %, or 80 to 96 wt. % of the core-sheath filament.

The adhesive core can be made using a number of different chemistries, including for instance, styrenic block copolymers, (meth)acrylics, (meth)acrylic block copolymers, natural rubber, styrene butadiene rubber, butyl rubber, polyisobutylene, ethylene vinyl acetate, amorphous poly(alpha-olefins), silicones, polyvinyl ether, polyisoprene, polybutadiene, butadiene-acrylonitrile rubber, polychloroprene, polyurethane, polyvinylpyrrolidone, or combinations thereof.

In many embodiments, the adhesive core comprises a styrenic block copolymer and a tackifier. Any number of styrenic block copolymers can be incorporated into the adhesive core; one, two, three, four, or even more different styrenic block copolymers may be included in the adhesive core. In some embodiments, a suitable styrenic block copolymer comprises a copolymer of a (meth)acrylate with a styrene macromer. In select embodiments, the adhesive core comprises a (meth)acrylic polymer.

Styrenic Block Copolymers

A suitable styrenic block copolymer has at least one rubbery block and two or more glassy blocks. The styrenic block copolymer is often a linear block copolymer of general formula (G-R)ₘ-G where G is a glassy block, R is a rubbery block, and m is an integer equal to at least 1. Variable m can be, for example, in a range of 1 to 10, in a range of 1 to 5, in a range of 1 to 3, or equal to 1. In many embodiments, the linear block copolymer is a triblock copolymer of formula G-R-G where the variable m in the formula (G-R)ₘ-G is equal to 1. Alternatively, a suitable styrenic block copolymer can be a radial (i.e., multi-arm) block copolymer of general formula (G-R)ₙ—Y where each R and G are the same as defined above, n is an integer equal to at least 3, and Y is the residue of a multifunctional coupling agent used in the formation of the radial block copolymer. The variable n represents the number of arms in the radial block copolymer and can be at least 4, at least 5, or at least 6 and often can be up to 10 or higher, up to 8, or up to 6. For example, the variable n is in a range of 3 to 10, in a range of 3 to 8, or in a range of 3 to 6.

In both the linear block copolymer and radial block copolymer versions of the styrenic block copolymer, the glassy blocks G can have the same or different molecular weight. Similarly, if there is more than one rubbery block R, the rubbery blocks can have the same or different molecular weights.

Generally, each rubbery block has a glass transition temperature (T_{g}) that is less than room temperature. For example, the glass transition temperature is often less than 20° C., less than 0° C., less than −10° C., or less than −20° C. In some examples, the glass transition temperature is less than −40° C. or even less than −60° C.

Each rubbery block R in the linear or radial block copolymers is typically the polymerized product of a first polymerized conjugated diene, a hydrogenated derivative of a polymerized conjugated diene, or a combination thereof. The conjugated diene often contains 4 to 12 carbon atoms. Example conjugated dienes include, but are not limited to, butadiene, isoprene, 2-ethylbutadiene, 1-phenylbutadiene, 1,3-pentadiene, 1,3-hexadiene, 2,3-dimethyl-1,3-butadiene, and 3-ethyl-1,3-hexadiene.

Each rubbery block R can be a homopolymer or copolymer. The rubbery block R is often poly(butadiene), poly(isoprene), poly(2-ethylbutadiene), poly(1-phenylbutadiene), poly(1,3-pentadiene), poly(1,3-hexadiene), poly(2,3-dimethyl-1,3-butadiene), poly(3-ethyl-1,3-hexadiene), poly(ethylene/propylene), poly(ethylene/butylene), poly(isoprene/butadiene), or the like. In many embodiments, the block R is polybutadiene, polyisoprene, poly(isoprene/butadiene), poly(ethylene/butylene), or poly(ethylene/propylene).

The glass transition temperature of each glassy block G is generally at least 50° C., at least 60° C., at least 70° C., at least 80° C., at least 90° C., or even at least 100° C.

Each glassy block G in the linear or radial block copolymers is typically the polymerized product of a first mono-vinyl aromatic monomer. The mono-vinyl aromatic monomer usually contains, for example, at least 8 carbon atoms, at least 10 carbon atoms, or at least 12 carbon atoms and up to 18 carbon atoms, up to 16 carbon atoms, or up to 14 carbon atoms. Example first mono-vinyl aromatic monomers include, but are not limited to, styrene, vinyl toluene, alpha-methyl styrene, 2,4-dimethyl styrene, ethyl styrene, 2,4-diethyl styrene, 3,5-diethyl styrene, alpha-2-methyl styrene, 4-tert-butyl styrene, 4-isopropyl styrene, and the like.

Each glassy block G can be a homopolymer or a copolymer. The glassy block G is often poly(styrene), poly(vinyl toluene), poly(alpha-methyl styrene), poly(2,4-dimethyl styrene), poly(ethyl styrene), poly(2,4-diethyl styrene), poly(3,5-diethyl styrene), poly(alpha-2-methyl styrene), poly(4-tert-butyl styrene), poly(4-isopropyl styrene), copolymers thereof, and the like.

In many embodiments, each glassy block G is polystyrene homopolymer or is a copolymer derived from a mixture of styrene and a styrene-compatible monomer, which is a monomer that is miscible with styrene. In most cases where the glassy phase is a copolymer, at least 50 weight percent of the monomeric units are derived from styrene. For example, at least 60 weight percent, at least 70 weight percent, at least 80 weight percent, at least 90 weight percent, at least 95 weight percent, at least 98 weight percent, or at least 99 weight percent of the monomeric units in the glassy block G is derived from styrene.

The styrenic block copolymer typically contains at least 5 weight percent and can contain up to 50 weight percent glassy blocks G. If the amount of glassy blocks G is too low, the cohesive strength may be too low because there is not sufficient physical crosslinking. On the other hand, if the amount of glassy blocks G is too high, the modulus may be too high (the composition may be too stiff and/or too elastic) and the resulting composition will not wet out well (spread on a surface such as on a substrate surface) when the molten adhesive is deposited on a substrate. For example, the styrenic copolymer often contains at least 6 weight percent, at least 7 weight percent, at least 8 weight percent, at least 9 weight percent, or at least 10 weight percent and up to 45 weight percent, up to 40 weight percent, up to 35 weight percent, up to 30 weight percent, up to 25 weight percent, up to 20 weight percent, or up to 15 weight percent glassy blocks G. The weight percent values are based on the total weight of the styrenic block copolymer. The remainder of the weight of the styrenic block copolymer is mainly attributable to the rubbery blocks.

In some embodiments, the styrenic block compound is a linear triblock copolymer and the triblock copolymer typically contains at least 10 weight percent glassy blocks G. For example, the triblock copolymer contains at least 15 weight percent or at least 20 weight percent glassy blocks. The amount of the glassy blocks in the triblock copolymer can be up to 35 weight percent. For example, the triblock copolymer can contain up to 30 weight percent or up to 25 weight percent glassy blocks G. In some examples, the triblock copolymer contains 10 to 35 weight percent, 10 to 30 weight percent, 10 to 25 weight percent, or 10 to 20 weight percent of the glassy blocks. The weight percent values are based on the total weight of the triblock copolymer. The remainder of the weight of the linear triblock copolymer is attributable to the rubbery block. For example, the linear triblock copolymer can contain 10 to 35 weight percent glassy blocks and 65 to 90 weight percent rubbery block, 10 to 30 weight percent glassy block and 70 to 90 weight percent rubbery block, 10 to 25 weight percent glassy block and 75 to 90 weight percent rubbery block, or 10 to 20 weight percent of the glassy blocks and 80 to 90 weight percent rubbery blocks based on a total weight of the linear triblock copolymer.

In addition to the glassy blocks G and the rubbery blocks R, styrenic block copolymers that are radial block copolymers include a multifunctional coupling agent J. The coupling agent often has multiple carbon-carbon double bonds, carbon-carbon triple bonds, or other groups that can react with carbamions of the living polymer used to form the radial block copolymers. The multifunctional coupling agents can be aliphatic, aromatic, heterocyclic, or a combination thereof. Examples include, but are not limited to, polyvinyl acetylene, diacetylene, di(meth)acrylates (e.g., ethylene dimethacrylate), divinyl benzene, divinyl pyridine, and divinyl thiophene. Other examples include, but are not limited to, multifunctional silyl halide (e.g., tetrafunctional silyl halide), polyepoxides, polyisocyanates, polyketones, polyanhydrides, polyalkenyls, and dicarboxylic acid esters.

The weight average molecular weight of the styrenic block copolymer is often no greater than 1,200,000 Daltons (Da). If the weight average molecular weight is too high, the copolymer would be difficult to extrude due to its high melt viscosity and would be difficult to blend with other materials. The weight average molecular weight is often no greater than 1,000,000 Da, no greater than 900,000 Da, no greater than 800,000 Da, no greater than 600,000 Da, or no greater than 500,000 Da. The weight average molecular weight of the styrenic block copolymer is typically at least 75,000 Da. If the weight average molecular weight is too low, the cohesive strength of the resulting adhesive may be unacceptably low. The weight average molecular weight is often at least 100,000 Da, at least 200,000 Da, at least 300,000 Da, or at least 400,000 Da. For example, the styrenic block copolymer can be in the range of 75,000 to 1,200,000 Da, in a range of 100,000 to 1,000,000 Da, in a range of 100,000 to 900,000 Da, or in a range of 100,000 to 500,000 Da. Radial block copolymers often have a higher weight average molecular weight than linear triblock copolymers. For example, in some embodiments, the radial block copolymers have a weight average molecular weight in a range of 500,000 to 1,200,000, in a range of 500,000 to 1,000,000 Da or in a range of 500,000 to 900,000 Da while the linear triblock copolymers have a weight average molecular weight in a range of 75,000 to 500,000 Da, in a range of 75,000 to 300,000 Da, in a range of 100,000 to 500,000 Da, or in a range of 100,000 to 300,000 Da.

Some styrenic block copolymers are polymodal block copolymers. As used herein, the term “polymodal” means that the two or more glassy blocks do not all have the same weight average molecular weight. The polymodal block copolymers are usually “asymmetric”, which means that the arms are not all identical. Such block copolymers can be characterized as having at least one “high” molecular weight glassy block and at least one “low” molecular weight glassy block, wherein the terms high and low are relative to each other. In some embodiments, the ratio of the number average molecular weight of the high molecular weight glassy block (Mn)_{H}, relative to the number average molecular weight of the low molecular weight glassy block (Mn)_{L} is at least 1.25. Methods of making asymmetrical, polymodal styrenic block copolymers are described, for example, in U.S. Pat. No. 5,296,547 (Nestegard et al.).

Some particular styrenic block copolymers have glassy blocks that are polystyrene and one or more rubbery blocks selected from polyisoprene, polybutadiene, poly(isoprene/butadiene), poly(ethylene/butylene), and poly(ethylene/propylene). Some even more particular styrenic block copolymers have glassy blocks that are polystyrene and one or more rubbery blocks selected from polyisoprene and polybutadiene, e.g., styrene butadiene rubber (SBR).

The styrenic block copolymers create physical crosslinks within the adhesive and contribute to the overall elastomeric character of the (e.g., pressure sensitive) adhesive. Typically, higher glassy block levels enhance the amount of physical crosslinking that occurs. More physical crosslinking tends to increase the shear strength of the adhesive.

In addition to the styrenic block copolymer described in detail above, a styrenic diblock copolymer may further be included in the core. This second styrenic copolymer can be separately added to the first styrenic block copolymer; however, many commercially available linear styrenic block copolymers (e.g., triblock copolymers) include some styrenic diblock copolymer. The diblock copolymer has a single glassy block G and a single rubbery block R. The diblock copolymer (G-R) can lower the viscosity of the adhesive and/or provide functionality that is typically obtained by addition of a plasticizer. Like a plasticizer, the diblock copolymer can increase the tackiness and low temperature performance of the resulting adhesive. The diblock copolymer also can be used to adjust the flow of the adhesive. The amount of diblock needs to be selected to provide the desired flow characteristics without adversely affecting the cohesive strength of the adhesive.

The same types of glassy blocks G and rubbery blocks R described above for use in the styrenic block copolymer (e.g., triblock and radial block copolymer) can be used for the styrenic diblock copolymer). Often, however, it can be advantageous to not select the same rubbery block for both block copolymers to facilitate the solubility of other components such as the tackifier in the core.

The amount of glassy block G in the styrenic diblock copolymer is often at least 10 weight percent based on a weight of the diblock copolymer. In some embodiments, the diblock contains at least 15 weight percent, at least 20 weight percent, or at least 25 weight percent glassy block. The amount of glassy block can be up to 50 weight percent, up 45 weight percent, up to 40 weight percent, up to 35 weight percent, or up to 30 weight percent. For example, the diblock can contain 10 to 50 weight percent, 10 to 40 weight percent, 15 to 50 weight percent, 15 to 40 weight percent, 20 to 50 weight percent or 20 to 40 weight percent glassy block. The weight percent values are based on the total weight of the diblock copolymer. The remainder of the weight of the diblock copolymer is mainly attributable to the rubbery block.

The weight average molecular weight of the styrenic diblock copolymer can be up to 250,000 Da, up to 225,000 Da, up to 200,000 Da, or up to 175,000 Da. If the molecular weight is too high, the diblock copolymer may not function to provide the desired flow characteristics or to provide other desired characteristics such as, for example, reducing the elastic modulus and/or increasing the tackiness of the (e.g., pressure-sensitive) adhesive. The weight average molecular weight is often at least 75,000 Da, at least 100,000 Da, at least 125,000 Da, or at least 150,000 Da. For example, weight average molecular weight of the diblock copolymer can be in a range of 75,000 to 250,000 Da, in a range of 100,000 to 250,000 Da, in a range of 125,000 to 250,000 Da, or in a range of 125,000 to 200,000 Da.

Suitable styrenic materials for use in the core, either alone or in combination, are commercially available under the trade designation KRATON (e.g., KRATON D 1161, D1340, D 116 P, D1118, D1119, and A1535) from Kraton Performance Polymers (Houston, Tex., USA), under the trade designation SOLPRENE (e.g., SOLPRENE S-1205) from Dynasol (Houston, Tex., USA), under the trade designation QUINTAC from Zeon Chemicals (Louisville, Ky., USA), and under the trade designations VECTOR and TAIPOL from TSRC Corporation (New Orleans, La., USA).

In some embodiments, the styrenic block copolymer may comprise a copolymer of a (meth)acrylate with a styrene macromer. This styrenic copolymer can be separately added to the core. Typically, this styrenic copolymer comprises the reaction product of a monomeric acrylate or a methacrylate ester of a non-tertiary alcohol with a styrene macromer and additional optional monomers. Suitable macromers include styrene/acrylonitrile copolymer and polystyrene macromers. Examples of useful macromers and their preparation are described in detail in U.S. Pat. No. 4,693,776 (Krampe et al.).

When the core includes a styrenic material, the (e.g., pressure-sensitive) adhesive contains 40 wt. % to 60 wt. % of one or more styrenic copolymers, based on the total weight of the adhesive, plus one or more tackifiers (and optionally additives). If the amount of the styrenic material is too low, the tackifier level may be too high and the resulting T_{g} of the composition may be too high for successful adhesion, particularly in the absence of a plasticizer. If the amount of the styrenic material is too high, however, the composition may have a modulus that is too high (e.g., the composition may be too stiff and/or too elastic) and the composition may not wet out well when the core-sheath filament is melted, mixed, and applied to a substrate. The amount of the styrenic material can be at least 45 weight percent or at least 50 weight percent and up to 55 weight percent or up to 50 weight percent. In some embodiments, the amount of the styrenic material is in a range of 40 to 60 weight percent, 40 to 55 weight percent, 40 to 50 weight percent, 45 to 60 weight percent, 45 to 55 weight percent, or 50 to 60 weight percent based on the total weight of the core.

Blowing Agents

Foams are porous materials that are composed of gas filled networks or chambers segmented by a solid matrix. The properties of foamed materials are governed by the composition of the matrix material and the morphology of its cellular structure. Blowing agents are employed to assist in forming foamed materials. Core-sheath filaments of the present disclosure comprise cores including a polymer and 1 wt. % to 10 wt. %, optionally 1 wt. % to 9 wt. %, optionally 1.5 wt. % to 8 wt. %, or optionally 2 wt. % to 6 wt. % of a blowing agent.

Control over the morphology of a foam's cell structure is often governed by the foaming method to which the matrix material is subjected. Historically, foaming has been achieved using either physical blowing agents (PBAs), which take advantage of the change in volume that occurs during first order phase transitions such as evaporation and sublimation or when a gas experiences a decrease in pressure; or chemical blowing agents (CBAs), which are molecules that decompose to gaseous species when heated. Blowing agent technology has advanced to include expandable microsphere (EMS), sold by AkzoNobel (now Nouryon) and Henkel (now Chase Corporation). These materials are composed of gas or liquid hydrocarbon PBAs inside a crosslinked polymer shell. When heated past the glass transition temperature (T_{g}) of the shell, the shell becomes malleable and expands due to the internal pressure of the heated PBA inside. The thickness of the shell and the quantity of PBA encapsulated is tuned to enable isotropic expansion rather than shell rupture, leading to an increase in volume.

A chemical blowing agent useful in embodiments of the present disclosure is typically a solid particulate blowing agent and may be selected from a diazocompound, a sulfonyl hydrazide, a tetrazole, a nitrosocompound, an acyl sulfonyl hydrazide, hydrazones, thiatriazoles, azides, sulfonyl azides, oxalates, thiatrizene dioxides, sodium bicarbonate, bicarbonate, carbonate, citric acid, citrate, or combinations thereof.

Examples of suitable chemical blowing agents include, for example, 1,1-azodicarboxamide (AZO), p-toluene sulfonyl hydrazide (Hydrazine), and 5H-phenyl tetrazole. AZO is one of the most common CBAs due to its high gas yield upon degradation and low cost. AZO decomposes when heated at or above 190° C. (with optimal temperatures between 190° C. and 230° C.) and gives off 220 mL/g nitrogen and carbon monoxide in the process, i.e., produces nitrogen gas upon activation. An example of a suitable AZO is an azodicarbonamide-based chemical foaming agent, available under the trade designation “PFM13691” from Techmer P M, Clinton, T N. Hydrazine is another common CBA and decomposes when heated at or above 150° C. (with optimal temperatures between 165° C. and 180° C.) and gives off 120 to 130 mL/g of ammonia, hydrogen, and nitrogen in the process. 5H-phenyl tetrazole is also a suitable CBA and decomposes when heated at or above 215° C. (with optimal temperatures between 240° C. and 250° C.) and gives off 195 to 215 mL/g of nitrogen in the process. Suitable carbon dioxide producing CBAs include, for example, Hydrocerol CF 40 from Clariant, Muttenz, Switzerland and EcoCell P from Polyfil Inc., Rockaway, N.J., USA.

Optionally, one or more additional materials may be co-encapsulated with the CBA. In some embodiments, the additional material comprises a metal oxide or metal salt, or combinations thereof. The metal oxide can be zinc oxide, calcium oxide, or a barium-cadmium complex, for example. In some embodiments, the metal salt can be of the form M(X)₂, wherein M is zinc, calcium, barium, or cadmium, and wherein X is an organic ligand containing a carboxylic acid moiety. Examples of suitable metal salts include for instance, zinc stearate, calcium stearate, barium-cadmium stearate, zinc 2-ethyl hexanoate, calcium 2-ethyl hexanoate, barium-cadmium 2-ethyl hexanoate, zinc acetate, calcium acetate, barium-cadmium acetate, zinc malonate, calcium malonate, barium-cadmium malonate, zinc benzoate, calcium benzoate, barium-cadmium benzoate, zinc salicylate, calcium salicylate, and barium-cadmium salicylate. Typically, the metal oxide and/or metal salt is present in the composite particle in an amount of 100 wt. % or less of the amount of the chemical blowing agent. In select embodiments, a metal oxide or metal salt is co-encapsulated in the composite particle when the chemical blowing agent is 1,1-azodicarboxamide or p-toluene sulfonyl hydrazide. It has been discovered that the metal oxide or metal salt can alter the decomposition temperature of the CBA.

Similarly, in some embodiments, the one or more additional materials co-encapsulated with the CBA comprises a polyhydroxyl compound, an amine containing compound, or a carboxylic acid containing compound. Examples of suitable polyhydroxyl compounds include for instance, glycerol, ethylene glycol, diethylene glycol, triethylene glycol, and combinations thereof. Examples of suitable carboxylic acid containing compounds include for instance, stearic acid, 2-ethylhexanoic acid, acetic acid, palmitic acid, and combinations thereof. Examples of suitable amine containing compounds include primary amines, for instance, monoethanolamine, diglycolamine, urea, biurea, cyanuric acid, guanidine, or combinations thereof. In select embodiments, an amine containing compound is co-encapsulated in the composite particle when the chemical blowing agent is p-toluene sulfonyl hydrazide.

The composite particle further includes a shell encapsulating the chemical blowing agent. It has been discovered that the use of an uncrosslinked thermoplastic material that has at least a certain minimum complex viscosity at the degradation temperature of the CBA alters the foaming process, as compared to the same CBA that is either not encapsulated or is encapsulated in an uncrosslinked thermoplastic material having a complex viscosity below the minimum amount at the degradation temperature of the CBA. Accordingly, the specific shell material selected will depend on the decomposition temperature of the CBA to be used. In many embodiments, the uncrosslinked thermoplastic material is selected from a starch, polyvinyl pyrollidinone (PVP), a copolymer of vinylpyrrolidone and vinyl acetate, a polypropylene-based elastomer, a styrene-isoprene-styrene copolymer, a (C1-C3)alkyl cellulose, a hydroxyl (C1-C3)alkylcellulose; carboxy methylcellulose, sodium carboxymethyl cellulose, a polyoxazoline, a silicone-based thermoplastic polymer, an olefin-based thermoplastic polymer, a phenoxy resin, a polyamide, or combinations thereof.

Water soluble starches are typically prepared by partial acid hydrolysis of starch. Examples of water soluble starches include those, for example, that are commercially available under the trade designation LYCOAT from Roquette (Lestrem, France). Examples of water soluble celluloses include, but are not limited to, alkyl cellulose (e.g., methyl cellulose, ethyl cellulose, ethyl methyl cellulose), hydroxylalkyl cellulose (e.g., hydroxymethyl cellulose, hydroxyethyl cellulose, hydroxypropyl cellulose, hydroxypropyl methyl cellulose, hydroxyethyl methyl cellulose, and hydroxyethyl ethyl cellulose), and carboxylalkyl cellulose (e.g., carboxymethyl cellulose).

Examples of suitable uncrosslinked thermoplastic materials include for instance and without limitation, hydroxylated starch, carboxylated starch, methyl cellulose, propyl cellulose, ethyl cellulose, hypromellose, hydroxypropylmethyl cellulose, hydroxypropyl cellulose, hydroxyethyl cellulose, or combinations thereof. In certain embodiments, the uncrosslinked thermoplastic material is selected from hydroxypropyl starch, PVP, a polyamide, a styrenic copolymer, or a combination thereof, preferably hydroxypropyl starch.

The weight average molecular weight of the uncrosslinked thermoplastic material is often at least 1,000 Daltons, at least 2,000 Daltons, at least 5,000 Daltons, or at least 10,000 Daltons. The weight average molecular weight can be up to 500,000 Daltons or higher. For example, the weight average molecular weight can be up to 300,000 Daltons, up to 200,000 Daltons, up to 100,000 Daltons, up to 50,000 Daltons, up to 20,000 Daltons. Some such uncrosslinked thermoplastic polymers can be obtained, for example, from Polysciences, Inc. (Warrington, Pa., USA).

The uncrosslinked thermoplastic material can have a higher complex viscosity than 3,700 Pa-s, for instance exhibiting a complex viscosity of 4,000 Pa-s or greater, 4,500 Pa-s or greater, 5,000 Pa-s or greater, 5,500 Pa-s or greater, or 6,000 Pa-s or greater at a decomposition temperature of the chemical blowing agent particle. Unexpectedly, although the uncrosslinked thermoplastic materials typically have glass transition temperatures below the decomposition temperature of the CBA, the shell can decrease diffusion of the gaseous CBA, affecting the foam formation. Without wishing to be bound by theory, it is believed that the viscous uncrosslinked thermoplastic material assists in preventing cell ripening, by minimizing the amount of gas that diffuses preferentially into a previously nucleated cell, but rather nucleates a new cell. This is based on the observed decreased cell size and increased cell density and homogeneity upon foaming with composite particles according to at least certain embodiments of the present disclosure, as compared to the cell size, density, and homogeneity upon foaming with unencapsulated CBAs.

Any suitable method can be used to deposit a coating of uncrosslinked thermoplastic material (i.e., shell) around the chemical blowing agent (e.g., core particle). Typically, an aqueous coating composition (e.g., coating solution or coating dispersion) is mixed with the CBA particles. Such mixture (i.e., a slurry) is then subjected to conditions effective to form dried composite particles as described herein.

In certain embodiments, the composition further comprises a blowing agent comprising a plurality of expandable microspheres. The blowing agent is present in an amount ranging from 0.1 to 10 weight percent, inclusive, based on the total weight of the composition. An “expandable microsphere” refers to a microsphere that includes a polymer shell and a core material in the form of a gas, liquid, or combination thereof, which expands upon heating. Expansion of the core material, in turn, causes the shell to expand, at least at the heating temperature. An expandable microsphere is one where the shell can be initially expanded or further expanded without breaking. Some microspheres may have polymer shells that only allow the core material to expand at or near the heating temperature. Hence, during the formation of the foam composition, at least some of the expandable microspheres will expand and form cells in the foam. In some embodiments, expandable microspheres useful in embodiments of the present disclosure may include, for example, those available from Matsumoto Yushi Seiyaku Co., Ltd. Osaka, Japan under the trade designation “MATSUMOTO MICROSPHERE F-2800D”; those available from Chase Corporation, Westwood, Mass. under the trade designation “DUALITE U010-185D”; those available from Pierce Stevens (Buffalo, N.Y.) under the designations “F30D”, “F80SD”, and “F100D”; and from Akzo-Nobel (Sundsvall, Sweden) under the designations “Expancel 551”, “Expancel 461”, “Expancel 091”, and “Expancel 930”. Each of these microspheres features an acrylonitrile-containing shell.

Optionally, one or more unencapsulated chemical blowing agents are also included in the composition. As described above, suitable chemical blowing agents include solid particulate blowing agents such as a diazocompound, a sulfonyl hydrazide, a tetrazole, a nitrosocompound, an acyl sulfonyl hydrazide, hydrazones, thiatriazoles, azides, sulfonyl azides, oxalates, thiatrizene dioxides, or any combination thereof.

In some embodiments, inorganic fillers may be used as antiblock additives to prevent blocking or sticking of layers or rolls of foam compositions during storage and transport. Inorganic fillers include clays and minerals, either surface modified or not. Examples include talc, diatomaceous earth, silica, mica, kaolin, titanium dioxide, perlite, and wollastonite.

Hence, certain materials may potentially act as more than one of a crystallization nucleating agent, a cell nucleating agent, an antiblock additive, a cell stabilizer, etc., in a composition.

Organic biomaterial fillers include a variety of forest and agricultural products, either with or without modification. Examples include cellulose, wheat, starch, modified starch, chitin, chitosan, keratin, cellulosic materials derived from agricultural products, gluten, flour, and guar gum. The term “flour” concerns generally a composition having protein-containing and starch-containing fractions originating from one and the same vegetable source, wherein the protein-containing fraction and the starch-containing fraction have not been separated from one another. Typical proteins present in the flours are globulins, albumins, glutenins, secalins, prolamins, glutelins. In typical embodiments, the composition comprises little or no organic biomaterial fillers such a flour. Thus, the concentration of organic biomaterial filler (e.g. flour) is typically less than 10, 9, 8, 7, 6, 5, 4, 3, 2, or 1 wt. % of the total foam composition.

Tackifier

When a styrenic material is incorporated in the core, a tackifier is typically used to impart tackiness to the adhesive. Examples of suitable tackifiers include rosins and their derivatives (e.g., rosin esters); polyterpenes and aromatic-modified polyterpene resins; coumarone-indene resins; hydrocarbon resins, for example, alpha pinene-based resins, beta pinene-based resins, limonene-based resins, aliphatic hydrocarbon-based resins, aromatic-modified hydrocarbon-based resins; or combinations thereof. Non-hydrogenated tackifiers are typically more colorful and less durable (i.e., weatherable). Hydrogenated (either partially or completely) tackifiers may also be used. Examples of hydrogenated tackifiers include, for example: hydrogenated rosin esters, hydrogenated acids, hydrogenated aromatic hydrocarbon resins, hydrogenated aromatic-modified hydrocarbon-based resins, hydrogenated aliphatic hydrocarbon-based resins, or combinations thereof. Examples of synthetic tackifiers include: phenolic resins, terpene phenolic resins, poly-t-butyl styrene, acrylic resins, or combinations thereof.

Exemplary hydrogenated hydrocarbon tackifiers include C9 and C5 hydrogenated hydrocarbon tackifiers. Examples of C9 hydrogenated hydrocarbon tackifiers include those sold under the trade designation: REGALITE S-5100, REGALITE R-7100, REGALITE R-9100, REGALITE R-1125, REGALITE S-7125, REGALITE S-1100, REGALITE R-1090, REGALREZ 6108, REGALREZ 1085, REGALREZ 1094, REGALREZ 1126, REGALREZ 1139, and REGALREZ 3103, sold by Eastman Chemical Co., Middelburg, Netherlands; PICCOTAC and EASTOTAC sold by Eastman Chemical Co.; ARKON P-140, ARKON P-125, ARKON P-115, ARKON P-100, ARKON P-90, ARKON M-135, ARKON M-115, ARKON M-100, and ARKON M-90 sold by Arakawa Chemical Inc., Chicago, Ill.; and ESCOREZ 5000 series sold by Exxon Mobil Corp., Irving, Tex. Examples of C5 hydrogenated hydrocarbon tackifiers include those sold under the trade designation: QUINTONE K100, QUINTONE B170, QUINTONE M100, and QUINTONE DX395 by Zeon Chemical, Louisville, Ky.

In some embodiments, the core may comprise a linear, (meth)acrylic-based polymeric tackifier. As used herein, the term “(meth)acrylic-based polymeric tackifier” refers to a polymeric material that is formed from a first monomer composition wherein at least 60 weight percent, at least 70 weight percent, at least 80 weight percent, at least 90 weight percent, at least 95 weight percent, at least 98 weight percent, at least 99 weight percent, or 100 weight percent of the monomers have a (meth)acryloyl group of formula —(CO)—CR═CH₂, where R is hydrogen or methyl. The (meth)acrylic-based polymeric tackifier has a glass transition temperature equal to at least 50° C. In some embodiments, the glass transition temperature (T_{g}) is at least 75° C. or at least 100° C. The glass transition temperature can be measured using a technique such as Differential Scanning Calorimetry or Dynamic Mechanical Analysis.

Some particular (meth)acrylic-based polymeric tackifiers contain up to 100 weight percent methyl methacrylate monomeric units. Other particular (meth)acrylic-based polymeric tackifiers contain a mixture of isobornyl (meth)acrylate monomeric units and a polar monomeric unit such as (meth)acrylic acid monomeric units or N,N-dimethylacrylamide monomeric units. Some suitable (meth)acrylic-based polymeric tackifiers are commercially available under the trade designation ELVACITE (e.g., ELVACITE 2008C, E2013, E2043, and E4402) from Lucite International incorporated (Cordova, Tenn., USA).

In some embodiments, the tackifier comprises an endblock tackifier with preferential solubility in styrene polymer domains, such as, for example, a polyarylene oxide (e.g., polyphenylene oxide) as disclosed in U.S. Pat. No. 6,777,080 (Khandpur et al.).

Any suitable amount of one or more tackifiers may be used. In some embodiments, the total amount of tackifier may be present in the core in an amount of 30 parts by weight or more, based on 100 parts by weight of total styrenic material. Optionally, the tackifier may be present in an amount of about 40 parts by weight to about 400 parts by weight, 40 parts by weight to about 200 parts by weight, 60 parts by weight to about 140 parts by weight, or even 80 parts by weight to about 120 parts by weight, based on the weight of the acrylic block copolymer.

(Meth)Acrylic Polymers

In certain embodiments, the core comprises one or more (meth)acrylic-based adhesive polymers. (Meth)acrylic-based polymers have been described, for example, in the following patent references: EP Patent Application 2072594 A1 (Kondou et al.), U.S. Pat. No. 5,648,425 (Everaerts et al.), U.S. Pat. No. 6,777,079 B2 (Zhou et al.), and U.S. Patent Application Publication 2011/04486 A1 (Ma et al.).

In some embodiments, the (meth)acrylic polymer comprises the reaction product of a polymerizable composition comprising a chain transfer agent, a polar monomer, and at least one alkyl (meth)acrylate. Suitable representative chain transfer agents, polar monomers, and alkyl (meth)acrylate monomers are each described in detail below.

Examples of suitable alkyl (meth)acrylate monomers incorporated into (meth)acrylic polymers include, but are not limited to, methyl methacrylate, ethyl methacrylate, propyl methacrylate, n-butyl methacrylate, sec-butyl methacrylate, isobutyl methacrylate, tert-butyl methacrylate, n-hexyl methacrylate, cyclohexyl methacrylate, 2-ethylhexyl (meth)acrylate, isooctyl acrylate, n-octyl methacrylate, and 3,3,5-trimethylcyclohexyl methacrylate, and isobornyl (meth)acrylate.

Examples of suitable non-acid functional polar monomers include, but are not limited to, 2-hydroxyethyl (meth)acrylate; N-vinylpyrrolidone; N-vinylcaprolactam; acrylamide; mono- or di-N-alkyl substituted acrylamide; t-butyl acrylamide; dimethylaminoethyl acrylamide; N-octyl acrylamide; poly(alkoxyalkyl) (meth)acrylates including 2-(2-ethoxyethoxy)ethyl (meth)acrylate, 2-ethoxyethyl (meth)acrylate, 2-methoxyethoxyethyl (meth)acrylate, 2-methoxyethyl methacrylate, polyethylene glycol mono(meth)acrylates; alkyl vinyl ethers, including vinyl methyl ether; and mixtures thereof. Preferred polar monomers include those selected from the group consisting of 2-hydroxyethyl (meth)acrylate and N-vinylpyrrolidinone.

Examples of suitable acid functional polar monomers include, but are not limited to, monomers where the acid functional group may be an acid per se, such as a carboxylic acid, or a portion may be salt thereof, such as an alkali metal carboxylate. Useful acid functional polar monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, carboxyethyl (meth)acrylate, 2-sulfoethyl methacrylate, styrene sulfonic acid, 2-acrylamido-2-methylpropanesulfonic acid, vinylphosphonic acid, and mixtures thereof. Due to their availability, acid functional polar monomers are generally selected from ethylenically unsaturated carboxylic acids, e.g., (meth)acrylic acids. When even stronger acids are desired, acidic polar monomers include the ethylenically unsaturated sulfonic acids and ethylenically unsaturated phosphonic acids may be used. The acid functional polar monomer is generally used in amounts of 1 to 15 parts by weight, preferably 1 to 10 parts by weight, based on 100 parts by weight total monomer.

A suitable monomer mixture may comprise: 50-99 parts by weight of alkyl (meth)acrylate monomers; and 1-50 parts by weight of polar monomers, (inclusive of acid-functional polar monomers); wherein the sum of the monomers is 100 parts by weight.

The polymerizable composition may optionally further comprise chain transfer agents to control the molecular weight of the resultant (meth)acrylate polymer. Examples of useful chain transfer agents include but are not limited to those selected from the group consisting of carbon tetrabromide, alcohols, mercaptans, and mixtures thereof. When present, the preferred chain transfer agents are isooctyl mercaptoacetate (e.g., commercially available from Evans Chemetics LP (Teaneck, N.J.)) and carbon tetrabromide. The polymerizable composition to form a (meth)acrylic polymer may further comprise up to about 1 part by weight of a chain transfer agent, typically about 0.01 to about 0.5 parts by weight, if used, preferably about 0.05 parts by weight to about 0.2 parts by weight, based upon 100 parts by weight of the total monomer mixture.

In certain embodiments a (meth)acrylic block copolymer may be used. Suitable (meth)acrylic block copolymers may have a block structure such as a di-block ((A-B) structure), a tri-block ((A-B-A) structure), a multi-block (-(A-B)n- structure), or a star block structure ((A-B)n- structure). Di-block, tri-block, and multi-block structures may also be classified as linear block copolymers. Star block copolymers fall into a general class of block copolymer structures having a branched structure. Star block copolymers are also referred to as radial or palmtree copolymers, as they have a central point from which branches extend. Block copolymers herein are to be distinguished from comb-type polymer structure and other branched copolymers. These other branched structures do not have a central point from which branches extend. The (meth)acrylic block copolymers can include any of the (meth)acrylic monomers described above. The (meth)acrylic block copolymer may comprise additional monomer units, for example, vinyl group monomers having carboxyl groups such as, e.g., (meth)acrylic acid, crotonic acid, maleic acid, maleic acid anhydride, fumaric acid, or (meth)acryl amide; aromatic vinyl group monomers such as, e.g., styrene, α-methyl styrene, or p-methyl styrene; conjugated diene group monomers such as, e.g., butadiene or isoprene; olefin group monomers such as, e.g., ethylene, or propylene; or lactone group monomers such as, e.g., ε-caprolactone or valero lactone; and combinations thereof. Example of (meth)acrylic block copolymer are available under the tradenames: Kurarity (available from Kuraray Chemical Corporation, Tokyo, Japan) and Nanostrength (available from Arkema, Colombes, France).

Methods of preparing the (meth)acrylic polymers for use in the core are not particularly limited; the (meth)acrylic polymer can be formed from the above-described polymerizable compositions by solution polymerization, emulsion polymerization, suspension polymerization, or bulk polymerization, as known to the skilled practitioner, for instance using typical polymerization initiation methods of ultraviolet radiation initiation and/or thermal initiation.

Additional Polymers

Poly(alpha-olefin) polymers, also referred to as poly(l-alkene) polymers, generally comprise an uncrosslinked polymer, which may have radiation activatable functional groups grafted thereon as described in U.S. Pat. No. 5,209,971 (Babu et al.). The polymer is tacky and predominantly amorphous. Useful poly(alpha-olefin) polymers include, for example, C₃-C₁₃ poly(1-alkene) homopolymers and copolymers of propylene with C₅-C₁₂ 1-alkenes, such as C₅-C₁₂ poly(1-alkene) polymers and copolymers of propylene with C₆-C₈ 1-alkenes. Examples of poly(alpha-olefins) are available under the trade designations: Rexene (from Rextac LLC, Oddessa, Tex.); Eastoflex (from Eastman Chemical Corp, Kingsport, Tenn.); and Vestoplast (Evonik, Essen, Germany).

Polyurethane is a generic term used to describe polymers prepared by the reaction of a polyfunctional isocyanate with a polyfunctional alcohol to form urethane linkages. The term “polyurethane” has also been used more generically to refer to the reaction products of polyisocyanates with any polyactive hydrogen compound including polyfunctional alcohols, amines, and mercaptans. The polyisocyanates may be linear or branched, aliphatic, cycloaliphatic, heterocyclic or aromatic or a combination thereof.

Silicone polymers include, for instance, a linear material described by the following formula illustrating a siloxane backbone with aliphatic and/or aromatic substituents:

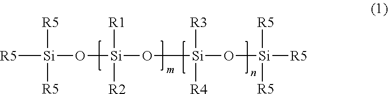

wherein R1, R2, R3, and R4 are independently selected from the group consisting of an alkyl group and an aryl group, each R5 is an alkyl group and n and m are integers, and at least one of m or n is not zero. In some embodiments, at least one of the alkyl or aryl groups may contain a halogen substituent (e.g., fluorine, for instance at least one of the alkyl groups may be —CH₂CH₂C₄F₉). In some embodiments, R5 is a methyl group (i.e., the nonfunctionalized silicone polymer is terminated by trimethylsiloxy groups). In some embodiments, R1 and R2 are alkyl groups and n is zero (i.e., the material is a poly(dialkylsiloxane)). In some embodiments, the alkyl group is a methyl group (i.e., poly(dimethylsiloxane) (“PDMS”)). In some embodiments, R1 is an alkyl group, R2 is an aryl group, and n is zero (i.e., the material is a poly(alkylarylsiloxane)). In some embodiments, R1 is methyl group and R2 is a phenyl group (i.e., the polymer is poly(methylphenylsiloxane)). In some embodiments, R1 and R2 are alkyl groups and R3 and R4 are aryl groups (i.e., the polymer is a poly(dialkyldiarylsiloxane)). In some embodiments, R1 and R2 are methyl groups, and R3 and R4 are phenyl groups (i.e., the polymer is poly(dimethyldiphenylsiloxane) or poly(methylphenylsiloxane)). In some embodiments, the nonfunctionalized silicone polymers may be branched. For example, at least one of the R1, R2, R3, and/or R4 groups may be a linear or branched siloxane with alkyl or aryl (including halogenated alkyl or aryl) substituents and terminal R5 groups. As used herein, “nonfunctional groups” are either alkyl or aryl groups consisting of carbon, hydrogen, and in some embodiments, halogen (e.g., fluorine) atoms. As used herein, a “nonfunctionalized silicone material” is one in which the R1, R2, R3, R4, and R5 groups are nonfunctional groups.

Generally, functional silicone polymers include specific reactive groups attached to the siloxane backbone of the starting material (e.g., hydrogen, hydroxyl, vinyl, allyl, or acrylic groups). As used herein, a “functionalized silicone polymer” is one in which at least one of the R-groups of Formula 2 is a functional group.

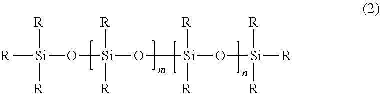

In some embodiments, a functional silicone polymer is one in which at least 2 of the R-groups are functional groups. Generally, the R-groups of Formula 2 may be independently selected. In some embodiments, the only functional groups present are hydroxyl groups (e.g., silanol terminated polysiloxanes (e.g., silanol terminated poly dimethyl siloxane)). In addition to functional R-groups, the R-groups may be nonfunctional groups (e.g., alkyl or aryl groups, including halogenated (e.g., fluorinated) alky and aryl groups). In some embodiments, at least one of the R groups may be a linear or branched siloxane with functional and/or non-functional substituents.

In embodiments in which the silicone polymer is non-tacky, a tackifier as described above may be included with the silicone polymer. A suitable tackifier resin often consists of a three dimensional silicate structure that is endcapped with trimethylsiloxy groups and silanol functionality. Suitable silicate tackifying resins are commercially available from sources such as Dow Corning (e.g., DC2-7066), and Momentive Performance Materials (e.g., SR545 and SR1000).

### Sheath

From a physical performance perspective, the properties of the sheath should be considered. The sheath provides structural integrity to the core-sheath filament, as well as separating the adhesive core from coming into contact with itself or other surfaces. The presence of the sheath preferably does not affect final material adhesive performance, either by being sufficiently thin to contribute a relatively small amount of filler material to the adhesive material or by being formed of material that is a functional component of the adhesive. The sheath does need to be thick enough to support the filament form factor and preferably to allow for delivery of the core-sheath filament to a deposition location.

In some embodiments, the sheath includes a polyolefin (e.g., a polyethylene homopolymer, a polyethylene-based copolymer, a polypropylene homopolymer, a polypropylene-based copolymer).

In some embodiments, the sheath material exhibits a melt flow index of less than 15 g/10 min. Such a low melt flow index is indicative of a sheath material that has sufficient strength to allow the core-sheath filament to withstand the physical manipulation required for handling, and optionally for use with an additive manufacturing apparatus. For instance, a core-sheath filament might need to be unwound from a spool, be introduced into an apparatus, and be advanced into a nozzle for melting, all without breakage of the core-sheath filament. In certain embodiments, the sheath material exhibits a melt flow index of 14 g/10 min or less, 13 g/10 min or less, 11 g/10 min or less, 10 g/10 min or less, 8 g/10 min or less, 7 g/10 min or less, 6 g/10 min or less, 5 g/10 min or less, 4 g/10 min or less, 3 g/10 min or less, 2 g/10 min or less, or 1 g/10 min or less. In addition to exhibiting strength, the sheath material is non-tacky. A material is non-tacky if it passes a “Self-Adhesion Test”, in which the force required to peel the material apart from itself is at or less than a predetermining maximum threshold amount, without fracturing the material. The Self-Adhesion Test is described in the Examples below. Employing a non-tacky sheath allows the filament to be handled and optionally printed, without undesirably adhering to anything prior to deposition onto a substrate.

In certain embodiments, the sheath material exhibits a combination of at least two of low MFI (e.g., less than 15 g/10 min), moderate elongation at break (e.g., 100% or more as determined by ASTM D638-14 using test specimen Type IV), low tensile stress at break (e.g., 10 MPa or more as determined by ASTM D638-14 using test specimen Type IV), and moderate Shore D hardness (e.g., 30-70 as determined by ASTM D2240-15).

In many embodiments, to achieve the goals of providing structural integrity and a non-tacky surface, the sheath comprises a material selected from a styrenic block copolymer, a polyolefin, ethylene vinyl acetate, a polyurethane, a styrene butadiene copolymer, either alone or in combination of any two or more. In certain embodiments, the sheath comprises any one of these listed materials as the main component (e.g., the sheath may also include one or more additives). Example suitable styrenic block copolymers and styrene butadiene copolymers are as described in detail above with respect to the core.

Suitable polyolefins are not particularly limited. Suitable polyolefin resins include for example and without limitation, polypropylene (e.g., a polypropylene homopolymer, a polypropylene copolymer, and/or blends comprising polypropylene), polyethylene (e.g., a polyethylene homopolymer, a polyethylene copolymer, high density polyethylene (HDPE), medium density polyethylene (MDPE), low density polyethylene (LDPE)), and combinations thereof. For instance, suitable commercially available LDPE resins include PETROTHENE NA217000 available from LyondellBasell (Rotterdam, Netherlands) and MARLEX 1122 available from Chevron Phillips (The Woodlands, Tex.).

The term “polyurethane” as used herein applies to polymers made from the reaction product of a compound containing at least two isocyanate groups (—N═C═O), referred to herein as “isocyanates”, and a compound containing at least two active-hydrogen containing groups. Examples of active-hydrogen containing groups include primary alcohols, secondary alcohols, phenols and water. Other active-hydrogen containing groups include primary and secondary amines which react with the isocyanate to form a urea linkage, thereby making a polyurea. A wide variety of isocyanate-terminated materials and appropriate co-reactants are well known, and many are commercially available (see, for example, Gunter Oertel, “Polyurethane Handbook”, Hanser Publishers, Munich (1985)). Suitable commercially available thermoplastic polyurethanes include for instance and without limitation, ESTANE 58213 and ESTANE ALR 87A available from the Lubrizol Corporation (Wickliffe, Ohio).

Suitable ethylene vinyl acetate (EVA) polymers (i.e., copolymers of ethylene with vinyl acetate) for use in the sheath include resins from DuPont (Wilmington, Del.) available under the trade designation ELVAX. Typical grades range in vinyl acetate content from 9 to 40 weight percent and a melt flow index of as low as 0.03 grams per minute. (per ASTM D1238). Suitable EVAs also include high vinyl acetate ethylene copolymers from LyondellBasell (Houston, Tex.) available under the trade designation ULTRATHENE. Typical grades range in vinyl acetate content from 12 to 18 weight percent. Suitable EVAs also include EVA copolymers from Celanese Corporation (Dallas, Tex.) available under the trade designation ATEVA. Typical grades range in vinyl acetate content from 2 to 26 weight percent.

In select embodiments, the sheath comprises one or more materials that are functional components of the adhesive of the adhesive core. In such embodiments, the sheath typically comprises a styrene block copolymer or a styrene butadiene copolymer, or combinations thereof. Advantageously, when such a core-sheath filament is melted, mixed, and deposited on a substrate, the sheath material adds to the adhesive properties of the adhesive, as opposed to potentially detracting from the adhesive properties. Optionally, the only structural polymeric materials (e.g., components other than additives) included in the sheath are functional components; in such embodiments the sheath consists of one or more (e.g., polymeric) materials that are functional components of the adhesive of the adhesive core.

In other embodiments, the sheath includes one or more materials that are not functional components of the adhesive of the adhesive core. In such embodiments, the sheath material can act as a filler in the adhesive when the core-sheath filament is melted, mixed, and deposited on a substrate. When the sheath includes one or more materials that are not functional components of an adhesive, they are typically included in a low weight percentage of the total core-sheath filament, to minimize interference with the adhesive properties of the final adhesive. For example, in an embodiment, the sheath comprises HDPE in an amount of up to 5 wt. % of the total weight of the core-sheath filament.

The sheath typically makes up 4 wt. % or more of the total core-sheath filament, 5 wt. % or more, 6 wt. % or more, 7 wt. % or more, 8 wt. % or more, 9 wt. % or more, 10 wt. % or more, 12 wt. % or more, or 13 wt. % or more of the total weight of the core-sheath filament; and 20 wt. % or less, 18 wt. % or less, 16 wt. % or less, 14 wt. % or less, 12 wt. % or less, 10 wt. % or less, or 8 wt. % or less of the total weight of the core-sheath filament. Stated another way, the sheath can be present in an amount of 4 wt. % to 20 wt. % of the core-sheath filament, 5 to 20 wt. %, 5 to 14 wt. %, 5 to 10 wt. %, or 4 to 8 wt. % of the core-sheath filament.

### Method of Printing

A method of printing a hot-melt processable adhesive is provided. The method includes forming a core-sheath filament as described above. The method further includes melting the core-sheath filament and blending the sheath with the core to form a molten composition. The method still further includes dispensing the molten composition through a nozzle onto a substrate. The molten composition can be formed before reaching the nozzle, can be formed by mixing in the nozzle, or can be formed during dispensing through the nozzle, or a combination thereof. Preferably, the sheath composition is uniformly blended throughout the core composition.

Fused filament fabrication (“FFF”), which is also known under the trade designation “FUSED DEPOSITION MODELING” from Stratasys, Inc., Eden Prairie, Minn., is a process that uses a thermoplastic strand fed through a hot can to produce a molten aliquot of material from an extrusion head. The extrusion head extrudes a bead of material in 3D space as called for by a plan or drawing (e.g., a computer aided drawing (“CAD”) file). The extrusion head typically lays down material in layers, and after the material is deposited, it fuses.

One suitable method for printing a core-sheath filament comprising an adhesive onto a substrate is a continuous non-pumped filament fed dispensing unit. In such a method, the dispensing throughput is regulated by a linear feed rate of the core-sheath filament allowed into the dispense head. In most currently commercially available FFF dispensing heads, an unheated filament is mechanically pushed into a heated zone, which provides sufficient force to push the filament out of a nozzle. A variation of this approach is to incorporate a conveying screw in the heated zone, which acts to pull in a filament from a spool and also to create pressure to dispense the material through a nozzle. Although addition of the conveying screw into the dispense head adds cost and complexity, it does allow for increased throughput, as well as the opportunity for a desired level of component mixing and/or blending. A characteristic of filament fed dispensing is that it is a true continuous method, with only a short segment of filament in the dispense head at any given point.

There can be several benefits to filament fed dispensing methods compared to traditional hot-melt adhesive deposition methods. First, filament fed dispensing methods typically permits quicker changeover to different adhesives. Also, these methods do not use a semi-batch mode with melting tanks and this minimizes the opportunity for thermal degradation of an adhesive and associated defects in the deposited adhesive. Filament fed dispensing methods can use materials with higher melt viscosity, which affords an adhesive bead that can be deposited with greater geometric precision and stability without requiring a separate curing or crosslinking step. In addition, higher molecular weight raw materials can be used within the adhesive because of the higher allowable melt viscosity. This is advantageous because uncured hot-melt pressure sensitive adhesives containing higher molecular weight raw materials can have significantly improved high temperature holding power while maintaining stress dissipation capabilities.

The form factor for FFF filaments is usually a concern. For instance, consistent cross-sectional shape and longest cross-sectional distance (e.g., diameter) assist in cross-compatibility of the core-sheath filaments with existing standardized FFF filaments such as ABS or polylactic acid (“PLA”). In addition, consistent longest cross-section distance (e.g., diameter) helps to ensure the proper throughput of adhesive because the FFF dispense rate is generally determined by the feed rate of the linear length of a filament. Suitable longest cross-sectional distance variation of the core-sheath filament according to at least certain embodiments when used in FFF includes a maximum variation of 20 percent over a length of 50 cm, or even a maximum variation of 15 percent over a length of 50 cm.

Extrusion-based layered deposition systems (e.g., fused filament fabrication systems) are useful for making articles including printed adhesives in methods of the present disclosure. Deposition systems having various extrusion types of are commercially available, including single screw extruders, twin screw extruders, hot-end extruders (e.g., for filament feed systems), and direct drive hot-end extruders (e.g., for elastomeric filament feed systems). The deposition systems can also have different motion types for the deposition of a material, including using XYZ stages, gantry cranes, and robot arms. Common manufacturers of additive manufacturing deposition systems include Stratasys, Ultimaker, MakerBot, Airwolf, WASP, MarkForged, Prusa, Lulzbot, BigRep, Cosin Additive, and Cincinnati Incorporated. Suitable commercially available deposition systems include for instance and without limitation, BAAM, with a pellet fed screw extruder and a gantry style motion type, available from Cincinnati Incorporated (Harrison, Ohio); BETABRAM Model P1, with a pressurized paste extruder and a gantry style motion type, available from Interelab d.o.o. (Senovo, Slovenia); AM1, with either a pellet fed screw extruder or a gear driven filament extruder as well as a XYZ stages motion type, available from Cosine Additive Inc. (Houston, Tex.); KUKA robots, with robot arm motion type, available from KUKA (Sterling Heights, Mich.); and AXIOM, with a gear driven filament extruder and XYZ stages motion type, available from AirWolf 3D (Fountain Valley, Calif.).

Three-dimensional articles including a printed adhesive can be made, for example, from computer-aided drafting (“CAD”) models in a layer-by-layer manner by extruding a molten adhesive onto a substrate. Movement of the extrusion head with respect to the substrate onto which the adhesive is extruded is performed under computer control, in accordance with build data that represents the final article. The build data is obtained by initially slicing the CAD model of a three-dimensional article into multiple horizontally sliced layers. Then, for each sliced layer, the host computer generates a build path for depositing roads of the composition to form the three-dimensional article having a printed adhesive thereon. In select embodiments, the printed adhesive comprises at least one groove formed on a surface of the printed adhesive. Optionally, the printed adhesive forms a discontinuous pattern on the substrate.

The substrate onto which the molten adhesive is deposited is not particularly limited. In many embodiments, the substrate comprises a polymeric part, a glass part, or a metal part. Use of additive manufacturing to print an adhesive on a substrate may be especially advantageous when the substrate has a non-planar surface, for instance a substrate having an irregular or complex surface topography. Before depositing molten adhesive to the surface of the substrate, the substrate is treated with one or more primers, as described above. The primer is typically applied as a solvent-borne liquid, by any suitable method, which may include, for example, brushing, spraying, dipping, and the like. In some embodiments, the substrate surface may be treated with one or more organic solvents (e.g., methyl ethyl ketone, aqueous isopropanol solution, acetone) prior to application of the primer.

The core-sheath filament can be extruded through a nozzle carried by an extrusion head and deposited as a sequence of roads on a substrate in an x-y plane. The extruded molten adhesive fuses to previously deposited molten adhesive as it solidifies upon a drop-in temperature. This can provide at least a portion of the printed adhesive. The position of the extrusion head relative to the substrate is then incremented along a z-axis (perpendicular to the x-y plane), and the process is repeated to form at least a second layer of the molten adhesive on at least a portion of the first layer. Changing the position of the extrusion head relative to the deposited layers may be carried out, for example, by lowering the substrate onto which the layers are deposited. The process can be repeated as many times as necessary to form a three-dimensional article including a printed adhesive resembling the CAD model. Further details can be found, for example, Turner, B. N. et al., “A review of melt extrusion additive manufacturing processes: I. process design and modeling”; Rapid Prototyping Journal 20/3 (2014) 192-204. In certain embodiments, the printed adhesive comprises an integral shape that varies in thickness in an axis normal to the substrate. This is particularly advantageous in instances where a shape of adhesive is desired that cannot be formed using die cutting of an adhesive. In some embodiments, it may desirable to apply only a single adhesive layer as it may be advantageous, for example, to minimize material use and/or reduce the size of the final bond line.

A variety of fused filament fabrication 3D printers may be useful for carrying out the method according to the present disclosure. Many of these are commercially available under the trade designation “FDM” from Stratasys, Inc., Eden Prairie, Minn., and subsidiaries thereof. Desktop 3D printers for idea and design development and larger printers for direct digital manufacturing can be obtained from Stratasys and its subsidiaries, for example, under the trade designations “MAKERBOT REPLICATOR”, “UPRINT”, “MOJO”, “DIMENSION”, and “FORTUS”. Other 3D printers for fused filament fabrication are commercially available from, for example, 3D Systems, Rock Hill, S.C., and Airwolf 3D, Costa Mesa, Calif.

In embodiments of the present disclosure, the heated extruder nozzle is heated to at least 170° C., at least 180° C., at least 190° C., or at least 200° C.

In certain embodiments, the method further comprises mixing the molten composition (e.g., mechanically) prior to dispensing the molten composition. In other embodiments, the process of being melted in and dispensed through the nozzle may provide sufficient mixing of the composition such that the molten composition is mixed in the nozzle, during dispensing through the nozzle, or both.

The temperature of the substrate onto which the adhesive can be deposited may also be adjusted to promote the fusing of the deposited adhesive. In the method according to the present disclosure, the temperature of the substrate may be, for example, at least about 100° C., 110° C., 120° C., 130° C., or 140° C. up to 175° C. or 150° C.

In some embodiments, the dispensed adhesive composition according to any of the formulations disclosed above exhibits average density be 0.1 g/cm³ to 0.9 g/cm³, optionally 0.5 g/cm³ to 0.8 g/cm³, or optionally 0.5 g/cm³ to 0.7 g/cm³ as measured by ASTM D3575-13 Suffix AA-Buoyancy test.

In some embodiments, the dispensed adhesive composition according to any of the formulations disclosed above exhibits a peel force of 20 N/cm to 100 N/cm, optionally 30 N/cm to 95 N/cm, or optionally 40 N/cm to 90 N/cm as measured by ASTM D6862 test.

In preferred embodiments, the dispensed adhesive composition according to any of the formulations disclosed above exhibits an average density of less than 0.9 g/cm³ as measured by ASTM D3575-13 Suffix AA-Buoyancy test and a peel force of greater than 30 N/cm as measured by ASTM D6862 test.

The printed adhesive prepared by the method according to the present disclosure may be an article useful in a variety of industries, for example, the aerospace, apparel, architecture, automotive, business machines products, consumer, defense, dental, electronics, educational institutions, heavy equipment, jewelry, medical, and toys industries. The composition of the sheath and the core can be selected so that, if desired, the printed adhesive is clear.

Foam adhesive formulations of the present disclosure may be particularly useful in automotive and industrial applications, such as, for example, in gap filling and sealing of irregularly shaped openings often found in appliances and/or automotive parts (e.g., automotive panels, refrigerator doors). The disclosed adhesives including closed-cell foam are also useful in sealing applications to prevent moisture transmission, and thus may be used in applications where moisture could lead to oxidation of parts (e.g., metal panels).

Objects and advantages of this disclosure are further illustrated by the following non-limiting examples, but the particular materials and amounts thereof recited in these examples, as well as other conditions and details, should not be construed to unduly limit this disclosure.

### Examples

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Mo., or may be synthesized by known methods. The following abbreviations are used in this section: min=minutes, s=second, g=gram, mg=milligram, kg=kilogram, m=meter, centimeter=cm, mm=millimeter, m=micrometer or micron, ° C.=degrees Celsius, ° F.=degrees Fahrenheit, N=Newton, oz=ounce, Pa=Pascal, MPa=mega Pascal, rpm=revolutions per minute, psi=pressure per square inch, cc/rev=cubic centimeters per revolution, cm³=centimeters cubed, in =inches, cc=cubic centimeters Table 1 (below) lists materials used in the examples and their sources.

TABLE 1
Material List

| Abbreviation | Description and Source |
|---|---|
| LDPE | Low Density Polyethylene, obtained under the trade designation “PETROTHENE |
| | NA217000” from Lyondell Bassell, Houston, TX |
| D1161 | Polystyrene-isoprene-styrene block copolymer, obtained under the trade |
| | designation “Di 161” from Kraton Corporation, Houston, TX |
| D1340 | Polystyrene-isoprene-styrene block copolymer, obtained under the trade |
| | designation “D1340” from Kraton Corporation, Houston, TX |
| K100 | C5 aliphatic hydrocarbon resin/tackifier, obtained under the trade designation |
| | “QUINTONE K100” from Zeon Chemical, Louisville, KY |
| Azo | Azodicarbonamide based chemical foaming agent, obtained under the trade |
| | designation “PFM13691” from Techmer PM, Clinton, TN |
| EcoCell P | Chemical foaming agent,obtained under the trade designation “ECOCELL P” |
| | from Polyfil Inc., Rockaway, NJ |
| F2800D | Thermo-expandable microcapsule, obtained under the trade designation |
| | “MATSUMOTO MICROSPHERE F-2800D” from Matsumoto Yushi Seiyaku |
| | Co., Ltd. Osaka, Japan |
| U010-185D | Heat expandable polymeric microsphere, obtained under the trade designation |
| | “DUALITE U010-185D” from Chase Corporation, Westwood, MA |
| Hydrocerol CF40 | Chemical foaming agent, obtained under the trade designation “HYDROCEROL |
| | CF40” from Clariant, Muttenz, Switzerland |
| Azo-in-PVP | Encapsulated chemical blowing agent of azodicarbonamide encapsulated with |
| | polyvinylpyrrolidone (PVP) prepared as described in PCT application |
| | 2019/125931 (Fishman et al.) |

### Test Procedures

### Density Measurements

The density of the foamed structures was measured using a pycnometer (obtained under the trade designation “DELTA RANGE” (Model AG204) from Mettler-Toledo, LLC, Columbus, Ohio). Samples were weighed dry (m_{dry}). Then the samples were placed under de-ionized water to measure the Buoyancy Force on the pycnometer. The Buoyancy Force (m_{buoyant}) was measured according to ASTM D3575-13 Suffix AA—Buoyancy (also called Specific Buoyancy). Using the formula below, the density (ρ_{foam}) was calculated by measuring the mass of the foamed sample in dry air (m_{dry}) and buoyant force (m_{buoyant}) of the sample in water. The density of the de-ionized water (ρ_{water}) is 1.00 g/cc. Three samples were measured and averaged to calculate an average density.

$${ρ}_{foam} = {ρ}_{water} ( \frac{{m}_{dry}}{{m}_{dry} - {m}_{buoyant}} )$$

90° Peel Strength Test: Core sheath filaments were fed into a dispenser set to 225° C. The dispenser comprised a 20 mm diameter single screw with mixing elements, length over diameter ratio of 12, and 3.1 mm diameter round orifice nozzle. The screw rotation was set to 100 RPM. The dispenser is further described in U.S. Pat. App. No. 62/810,248.

The 90° Peel Strength Test was carried out in accordance with ASTM D6862-11 (2016) with the following modifications. A 1.5-millimeter thick by 125-millimeter long strip of sample adhesive was dispensed directly onto a substrate (100 mm by 305-millimeter anodized aluminum panel obtained from Lawrence & Frederick Inc, Streamwood, Ill., United States) by manually moving the substrate at 25 mm/s under the stationary dispenser. The strip width varied between 6 millimeters to 10 millimeters, depending on the volume change associated with foaming. An aluminum foil strip (15 millimeters wide and 150 millimeters long) was manually laminated to the exposed sample adhesive surface using a 50-millimeter diameter rubber roller and hand pressure light enough to avoid deforming the adhesive thickness less than 1.5 millimeters. The bonded samples were allowed to dwell for 24 hours at 25° C. and 50% humidity. The peel test was carried out using a tensile tester equipped with a 50-kilonewton load cell at room temperature with a separation rate of 30.5 centimeters/minute. The average peel force was normalized by strip width. recorded and used to calculate the average peel adhesion strength in newtons/centimeter. Two replicates were tested at each condition, and the peel adhesion strength values were averaged. A peel adhesion strength greater than 30 newtons/centimeter is desired.

All core compositions are summarized in Table 2 and Table 3 with preparations described below.

### Core 1-14 (C1-C14) Preparation: Preparation of Core to be Used in Examples 1-14

Materials were coextruded using a 25 mm twin screw extruder (obtained from Krupp Werner & Pfilederer, Ramsey, N.J., USA) to supply the core material. A 10 cc/rev melt pump Zenith PEP II Series (obtained from Zenith Pumps, Monroe, N.C., USA) was attached to the end of twin-screw extruder to provide consistent flow. Two gravimetric feeders (obtained under the trade designation MODEL KT20 from Coperion, Stuutgart, Germany) fed pellets and powder into the twin-screw extruder. Tackifier was supplied to the twin screw extruder using an adhesive supply unit (obtained under the trade designation “DYNATMELT” from ITW Dynatec, Hendersonville, Tenn., USA). The twin screw extruder screw was set to 125 revolutions per minute (rpm), the barrel temperatures were set to 154° C. (310° F.). Various compositions of chemical foaming agent or expandable microspheres were added to the twin screw extruder according to the compositions listed below.

TABLE 2
Core Compositions

| | Core Composition | | | |
|---|---|---|---|---|
| Core | D1161 | K100 | D1340 | Blowing Agent |
| C1 | 50.0% | 50.0% | 0.0% | 0.0% |
| C2 | 49.0% | 49.0% | 0.0% | 2.0% Azo |
| C3 | 48.0% | 48.0% | 0.0% | 4.0% Azo |
| C4 | 45.5% | 45.5% | 0.0% | 9.0% Azo |
| C5 | 48.0% | 48.0% | 0.0% | 4.0% EcoCell P |
| C6 | 45.5% | 45.5% | 0.0% | 9.0% EcoCell P |
| C7 | 40.0% | 50.0% | 10.0% | 0.0% |
| C8 | 39.0% | 49.0% | 10.0% | 2.0% Azo |
| C9 | 38.5% | 48.0% | 9.6% | 3.9% Azo |
| C10 | 49.0% | 49.0% | 0.0% | 2.0% F2800D |
| C11 | 48.0% | 48.0% | 0.0% | 4.0% F2800D |
| C12 | 49.0% | 49.0% | 0.0% | 2.0% U010-185D |
| C13 | 49.0% | 49.0% | 0.0% | 2.0% Azo-in-PVP |
| C14 | 48.0% | 48.0% | 0.0% | 4.0% HydrocerolCF40 |

### Core 15-16 (C15-C16) Preparation: Preparation of Core to be Used in Examples 15-16

For Cores 15 and 16, the twin screw extruder barrel was set to 204° C. (400° F.). This increase in temperature was enough to activate the blowing agent in the filament making process. Various compositions of chemical foaming agent or expandable microspheres were added to the twin screw extruder according to the compositions listed below.

TABLE 3
Core Compositions

| | Core Composition | | | |
|---|---|---|---|---|
| Core | D1161 | K100 | D1340 | Blowing Agent |
| C15 | 48.0% | 48.0% | 0.0% | 4.0% F2800D |
| C16 | 49.0% | 49.0% | 0.0% | 2.0% Azo |

All Examples, Examples 1-16 (EX1-E16) are summarized in Tables 4 and 5 with preparations described below.

### Sheath Preparation

A 1.25″ single screw extruder (obtained from Killion Extruders Inc., Cedar Grove, N.J., USA) was used to supply the low-density polyethylene (LDPE) sheath material.

### Core-Sheath Filament Preparation

Core-sheath filaments were made by co-extruding a non-tacky outer sheath layer around an inner PSA core with heated hoses (obtained from Diebolt & Co., Old Lyme, Conn., USA) connecting the extruders to the core-sheath die. Core sheath filaments were fed into a dispenser set to 225° C. The dispenser comprised a 20 mm diameter single screw with mixing elements, length over diameter ratio of 12, and 3.1 mm diameter round orifice nozzle. The screw rotation was set to 100 RPM. The dispenser is further described in U.S. Pat. App. No. 62/810,248.

TABLE 4
Core-Sheath Filament Compositions

| | LDPE | | | | |
|---|---|---|---|---|---|
| Example | NA217000 | D1161 | K100 | D1340 | Blowing Agent |
| EX1 | 9.1% | 45.5% | 45.5% | | |
| EX2 | 8.9% | 44.6% | 44.6% | | 1.8% Azo |
| EX3 | 8.8% | 43.9% | 43.9% | | 3.5% Azo |
| EX4 | 8.3% | 41.7% | 41.7% | | 8.3% Azo |
| EX5 | 8.8% | 43.9% | 43.9% | | 3.5% EcoCell P |
| EX6 | 8.3% | 41.7% | 41.7% | | 8.3% EcoCell P |
| EX7 | 9.1% | 36.4% | 45.5% | 9.1% | |
| EX8 | 8.9% | 35.7% | 44.6% | 8.9% | 1.8% Azo |
| EX9 | 8.8% | 35.1% | 43.9% | 8.8% | 3.5% Azo |
| EX10 | 8.9% | 44.6% | 44.6% | | 1.8% F2800D |
| EX11 | 8.8% | 43.9% | 43.9% | | 3.5% F2800D |
| EX12 | 8.9% | 44.6% | 44.6% | | 1.8% U010-185D |
| EX13 | 8.9% | 8.9% | 8.9% | | 1.8% Azo-in-PVP |
| EX14 | 8.8% | 43.9% | 43.9% | | 3.5% HydrocerolCF40 |

TABLE 5
Core-Sheath Filament Compositions

| | LDPE | | | |
|---|---|---|---|---|
| Example | NA217000 | D1161 | K100 | Blowing Agent |
| EX15 | 8.8% | 43.9% | 43.9% | 3.5% F2800D |
| EX16 | 8.9% | 44.6% | 44.6% | 1.8% Azo |

### Results

Density of Samples after Dispensing

Table 6 shows the density measurements and calculations for Examples 1-16 (EX1-EX16).

TABLE 6
Density of Core-Filament Samples
After Dispensing

| | Average | |
|---|---|---|
| | Density | % Change in |
| Example | (g/cc) | Density |
| EX1 | 0.934 | 0% |
| EX2 | 0.763 | 18% |
| EX3 | 0.697 | 25% |
| EX4 | 0.577 | 38% |
| EX5 | 0.870 | 7% |
| EX6 | 0.834 | 11% |
| EX7 | 0.934 | 0% |
| EX8 | 0.760 | 19% |
| EX9 | 0.678 | 27% |
| EX10 | 0.933 | 0% |
| EX11 | 0.733 | 21% |
| EX12 | 0.551 | 41% |
| EX13 | 0.662 | 29% |
| EX14 | 0.822 | 12% |
| EX15 | 0.653 | 30% |
| EX16 | 0.810 | 13% |

### Core-Sheath Filament PSA Performance

Table 7 shows the testing results for 90 Degree Peel Test for the core-sheath materials used in Examples 1-16 (EX1-EX16).

TABLE 7
Core-Sheath Filament Samples 90 Degree
Peel Test Results

| | | | Average |
|---|---|---|---|
| | Thickness, | Width, | Load, |
| Example | mm | mm | N/cm |
| EX1 | 1.5 | 8 | 98 |
| EX2 | 1.7 | 8 | 58 |
| EX3 | 1.5 | 9 | 38 |
| EX4 | 1.8 | 10 | 34 |
| EX5 | 2 | 8 | 46 |
| EX6 | 1.8 | 10 | 34 |
| EX7 | 1.8 | 10 | 93 |
| EX8 | 2 | 10 | 50 |
| EX9 | 1.7 | 9 | 44 |
| EX10 | 1.8 | 8 | 78 |
| EX11 | 1.8 | 6 | 37 |
| EX12 | 1.5 | 6 | 20 |
| EX13 | 1.6 | 8 | 49 |
| EX14 | 1.6 | 8 | 23 |
| EX15 | 1.5 | 6 | 24 |
| EX16 | 1.5 | 7 | 29 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A core-sheath filament comprising:
a non-tacky sheath; and
an adhesive core, wherein the adhesive core comprises:
a polymer; and
1 wt. % to 10 wt. % of a blowing agent.

2. The core-sheath filament of claim 1, wherein the non-tacky sheath comprises a polyolefin.

3. The core-sheath filament of claim 1, wherein the non-tacky sheath exhibits a melt flow index of less than 15 grams per 10 minutes (g/10 min).

4. The core-sheath filament of claim 1, wherein the core-sheath filament comprises 1 to 10 wt. % sheath and 90 to 99 wt. % adhesive core based on a total weight of the core-sheath filament.

5. The core-sheath filament of claim 1, wherein the core-sheath filament has a cylindrical shape.

6. The core-sheath filament of claim 1, wherein the adhesive core comprises 1 wt. % to 9 wt. %, optionally 1.5 wt. % to 8 wt. %, or optionally 2 wt. % to 6 wt. % of the blowing agent.

7. The core-sheath filament of claim 1, wherein the blowing agent is a chemical blowing agent.

8. The core-sheath filament of claim 7, wherein the chemical blowing agent produces nitrogen gas upon activation.

9. The core-sheath filament of claim 1, wherein the blowing agent is an expandable microsphere blowing agent.

10. The core-sheath filament of claim 1, wherein the polymer comprises a styrenic block copolymer.

11. The core-sheath filament of claim 10, wherein the styrenic block copolymer comprises a mixture of two or more of styrenic diblock, styrenic triblock, and styrenic star block copolymers.

12. The core-sheath filament of claim 1, wherein the adhesive core further comprises a tackifier.

13. The core-sheath filament of claim 12, wherein the tackifier comprises an endblock tackifier with preferential solubility in styrene polymer domains.

14. The core-sheath filament of claim 12, wherein the core comprises 20 w. % to 60 wt. %, optionally 24 wt. % to 55 wt. %, or optionally 26 wt. % to 50 wt. % of the tackifier based on a total weight of the adhesive core.

15. The core-sheath filament of claim 1, wherein the adhesive core further comprises an additive selected from the group consisting of a filler, a plasticizer, an antioxidant, a pigment, a dye, a hindered amine light stabilizer, an ultraviolet light absorber, and combinations thereof.

16. The core-sheath filament of claim 1, wherein the adhesive core is a pressure-sensitive adhesive.

17. A dispensed adhesive composition comprising the core-sheath filament of claim 1, the dispensed adhesive composition being a product resulting from compounding the core-sheath filament through a heated extruder nozzle.

18. The dispensed adhesive composition of claim 17, wherein the dispensed adhesive composition exhibits an average density of less than 0.9 g/cm³ as measured by ASTM D3575-13 Suffix AA-Buoyancy test and peel force of greater than 30 N/cm as measured by ASTM D6862-11 test.

19. A method of making a core-sheath filament, the method comprising:
a) forming a core composition comprising the adhesive core of claim 1;
b) forming a sheath composition comprising a non-tacky thermoplastic material; and
c) wrapping the sheath composition around the core composition to form the core-sheath filament, wherein the core-sheath filament has an average longest cross-sectional distance in a range of 1 to 20 millimeters.

20. The method of claim 19, wherein the wrapping the sheath composition around the core composition comprises co-extruding the core composition and the sheath composition such that the sheath composition surrounds the core composition.
